(19) United States
(12) Patent Application Publication
(10) Pub. No.: US 2023/0318124 A1
(43) Pub. Date: Oct. 5, 2023

(54) DEGASSING UNIT ASSEMBLY, DEGASSING UNIT, AND BATTERY HOUSING

(71) Applicant: MANN+HUMMEL GmbH, Ludwigsburg (DE)

(72) Inventor: Martin PLOPPA, Stuttgart (DE)

(21) Appl. No.: 18/321,758

(22) Filed: May 22, 2023

Related U.S. Application Data
(63) Continuation of application No. PCT/EP2021/079771, filed on Oct. 27, 2021.

(30) Foreign Application Priority Data
Dec. 3, 2020 (DE) 102020132188.0

(51) Int. Cl. H01M 50/342

(52) U.S. Cl. CPC H01M 50/3425

(57) ABSTRACT

A degassing unit assembly for closing a housing opening of a battery housing has degassing units arranged adjoining each other, each having a carrier body with a gas through-opening for discharging gases or pressure compensation. The gas through-opening extends continuously through the carrier body in axial direction. The carrier body has a rim surrounding the gas through-opening. The rim has at least one fastening dome and at least one contact region. At least two of the degassing units are end pieces. In a mounted state of the degassing units, the fastening dome of the carrier body of a first degassing unit forms, at least in sections, an overlap region in axial direction with the contact region of the carrier body of a second degassing unit adjoining the first degassing unit. A degassing unit for such an assembly and a battery housing comprising such an assembly are provided.

### CROSS-REFERENCE TO RELATED APPLICATIONS

This application is a continuation application of International Application No. PCT/EP2021/079771 filed on Oct. 27, 2021, which claims the benefit of German Application No. 102020132188.0 filed on Dec. 3, 2020, the entire disclosures of which are incorporated herein by reference for all purposes.

### BACKGROUND

The invention concerns a degassing unit assembly for closing a housing opening of a battery housing, a degassing unit, a use of a degassing unit in a degassing assembly as well as a battery housing with a degassing unit assembly.

Housings for receiving electronic components such as, for example, battery cells and the like, cannot be closed completely gas-tightly in relation to the environment because, on the one hand, due to temperature fluctuations, for example, by heat introduction during loading or discharging of battery cells, and, on the other hand, due to naturally occurring air pressure fluctuations, in particular in mobile systems, a gas exchange between interior and exterior must be enabled in order to prevent impermissible mechanical loads of the housing, in particular a bursting or bulging of the housing.

It is however likewise important that the ingress of foreign bodies, dirt, and moisture in the form of liquid water is effectively prevented. Therefore, pressure compensation devices are known which comprise semipermeable membranes, for example, of extruded polytetrafluoroethylene (PTFE), which are gas-permeable but liquid-impermeable.

DE 10 2012 022 346 B4 discloses a battery housing which comprises a housing enclosing a housing interior and comprising a housing opening which is covered by a membrane carrier in the form of a housing cover and provided for degassing and for substantially water-tight sealing of the housing interior against ingress of water, preferably also of other liquids, which membrane carrier contains a carrier body which comprises a gas through-opening for discharge of gases or for pressure compensation which extends between a carrier body inner side and a carrier body outer side. The gas through-opening is completely covered by a semipermeable membrane. The carrier body, the membrane, and the housing are connected air-tightly or gas-tightly so that substantially no water and preferably also no air or no gas can pass through the housing opening into the housing interior.

### SUMMARY

An object of the invention is to provide a degassing unit assembly for closing a housing opening of a battery housing which makes it possible to arrange a plurality of degassing units in an efficient manner.

A further object is to provide a degassing unit for such a degassing unit assembly.

A further object is to realize an efficient use of a degassing unit in such a degassing assembly.

A further object is to provide a battery housing with such a degassing unit assembly.

The aforementioned object is solved according to an aspect of the invention by a degassing unit assembly for closing a housing opening of a battery housing, comprising at least two degassing units which are arranged adjoining each other in a direction perpendicular to an axial direction corresponding to a surface normal of the degassing units, wherein at least two of the degassing units are embodied as end pieces, and wherein the degassing units respectively comprise at least a carrier body, which comprises a gas through-opening for discharge of gases or for pressure compensation extending continuously through the carrier body in axial direction, wherein the carrier body respectively comprises at least one rim surrounding the gas through-opening, which rim comprises at least one fastening dome and at least one contact region embodied in the rim, and wherein, in the mounted state, the at least one fastening dome of one degassing unit forms, at least in sections, an overlap region in axial direction with the corresponding at least one contact region of the adjoining degassing unit.

The further object according to a further aspect of the invention is solved by a degassing unit for a degassing unit assembly for closing a housing opening of a battery housing, comprising a carrier body which comprises a gas through-opening for discharge of gases or for pressure compensation extending continuously through the carrier body in an axial direction, wherein the carrier body comprises a rim surrounding the gas through-opening, which rim comprises at least one fastening dome and at least one contact region, and wherein the at least one fastening dome comprises a fastening flange comprising an outwardly curved collar and extending farther in axial direction than the rim.

The further object is solved according to a further aspect of the invention by a use of a degassing unit in a degassing assembly, wherein the degassing unit respectively comprises at least a carrier body which comprises a gas through-opening extending continuously through the carrier body for discharging gases or for pressure compensation, wherein the carrier body respectively comprises at least one fastening dome formed in a circumferentially extending rim and at least one contact region formed in the rim, wherein at least two degassing units are arranged adjoining each other in a direction perpendicular to an axial direction of the degassing units, wherein at least two of the degassing units are embodied as end pieces, and wherein, in the mounted state, the at least one fastening dome of a degassing unit forms, at least in sections, an overlap region in axial direction with the corresponding at least one contact region of the adjoining degassing unit.

The further object is solved according to a further aspect of the invention by a battery housing with a degassing unit assembly, comprising a housing enclosing a housing interior and comprising a housing opening, wherein the housing opening is covered by the degassing unit assembly which is provided for degassing or for pressure compensation and for substantially water-tight sealing of the housing interior against ingress of water and which is connected substantially water-tightly to the housing.

Beneficial configurations and advantages of the invention result from the additional claims, the description, and the drawing.

According to an aspect of the invention, a degassing unit assembly for closing a housing opening of a battery housing is proposed, comprising at least two degassing units which are arranged adjoining each other in a direction perpendicular to an axial direction corresponding to a surface normal of the degassing units, wherein at least two of the degassing units are embodied as end pieces. The degassing units respectively comprise at least a carrier body which comprises a gas through-opening extending continuously through the carrier body in axial direction for discharging gases or for pressure compensation. The carrier body respectively comprises at least one rim surrounding the gas through-opening, which rim comprises at least one fastening dome and at least one contact region formed in the rim. In the mounted state, the at least one fastening dome of a degassing unit forms, at least in sections, an overlap region in axial direction with the corresponding at least one contact region of the adjoining degassing unit in this context.

Advantageously, a modular degassing unit assembly for battery housings is provided, in particular for traction battery housings of motor vehicles. The individual degassing units of the assembly respectively comprise at least one fastening dome and at least one contact region as connection elements with which one of the degassing units can be connected to an adjoining degassing unit and to a battery housing. The modular degassing unit assembly comprises at least two individual degassing units which share at least one fastening dome and a contact region corresponding therewith so that at least one of the degassing units is indirectly connectable to the battery housing by means of a fastening dome of the adjoining degassing unit which engages, for example, across the contact region of the degassing unit in the overlap region. Fastening dome and contact region are formed in a rim of a carrier body of the degassing unit, the rim being substantially of a planar configuration.

In the modular degassing unit assembly, an embodiment can be comprised, for example, of two degassing units which are arranged adjacent to each other in a plane which is positioned perpendicularly to the surface normals of the degassing units, wherein one of the degassing units is rotated by 180° relative to the other degassing unit. In this context, a respective fastening dome of a degassing unit can overlap the corresponding contact region, for example, engage across the corresponding contact region of the respective adjoining other degassing unit, and the two degassing units can be directly connected in this way so as to adjoin each other. In this arrangement, the thus formed degassing unit assembly can be connected to a battery housing by the two fastening domes and by possibly existing further fastening devices and cover a housing opening in the battery housing air-tightly and water-tightly.

For an advantageous force introduction during the fixation at a battery housing, fastening domes and contact regions of the degassing units can be arranged at corners of an otherwise substantially areally embodied, for example, cuboid, body.

In this manner, degassing unit assemblies advantageously not only can be formed by linear or line-wise stringing of degassing units. Beneficially, also areally embodied degassing unit assemblies can thus be formed in that a plurality of rows of degassing units are arranged adjacent to each other.

The carrier body of the degassing unit comprises a gas through-opening which extends continuously through the carrier body in axial direction for discharging gases or for pressure compensation and which is covered completely by a membrane cover part of a membrane.

When inside of the battery housing a pressure peak is generated, for example, upon failure of a battery cell in the battery housing, this pressure must be relieved as quickly as possible because otherwise the housing might become damaged. In case of high-voltage batteries, in particular lithium-based traction batteries for electrically driven vehicles with significantly higher storage capacities and power densities, highly specific pressure compensation devices are used which are optimized for relief of pressure peaks in the battery housing.

Due to the continuously increasing storage capacity of the batteries used in vehicles, also an enlargement of the construction volume of the battery housing is entailed. In many cases, it is therefore no longer sufficient to provide a single degassing unit at the battery housing but it is necessary, in particular for the critical emergency degassing situation, to provide often two, three, or even more degassing units in order to provide the required flow cross sections for emergency degassing.

For the normal operation situation which resides in compensation of atmospheric air pressure fluctuations, often only one degassing unit is sufficient however.

In the degassing unit assembly according to the invention, therefore a modular arrangement of various degassing units is provided of which, for example, only one degassing unit is provided for compensation of air pressure fluctuations while the remaining degassing units are provided for the emergency degassing situation of a fast pressure increase in the battery housing.

The proposed modular configuration according to the invention makes it advantageously possible to provide the individual degassing unit less expensively because material usage and screw connection points, for example, in the form of a threaded bushing, can be minimized.

Usually, as semipermeable air-permeable but water-blocking membrane of a degassing unit, a PTFE membrane is used which contributes a large proportion of the total costs of a degassing unit. Advantageously, in the degassing unit assembly according to the invention it is now possible to use in individual degassing units a non-air-permeable or only minimally air-permeable membrane or gas-tight film as a membrane which is provided only for the perforation in case of an emergency degassing. This represents an additional significant cost savings for the assembly considered as a whole.

Advantageously, as already mentioned, at least one degassing opening of a degassing unit is covered by a semipermeable membrane which is gas-permeable but at least substantially water-tight. The membrane ensures that the gases which are produced in the batteries or rechargeable batteries are guided through the membrane to the exterior and discharged into the atmosphere. At the same time, ingress of water from the exterior to the interior which could lead to a functional limitation or even to a destruction is reliably prevented. Thus, such a battery housing is also suitable for application situations in which the battery housing is exposed to an external water load, for example, in vehicles. The semipermeable membrane which covers the degassing opening prevents completely a water ingress from the exterior up to a defined water pressure, in particular up to a water pressure in the range of 100 to 3,000 mm water column, i.e., a water pressure of 250 mm water column.

A pressure compensation between the interior of the battery housing or between the interior of the battery or of the rechargeable battery and the environment is ensured also through the semipermeable membrane. The maximally permissible pressure difference between the inner pressure in the battery housing and the outer or ambient pressure is limited by air exchange which is possible in both directions through the membrane.

As the semipermeable membrane, all materials can be used that comprise a gas permeability for permanent venting and a sufficiently high water impermeability. As preferred material for the semipermeable membrane, polytetrafluoroethylene (PTFE) can be used. The semipermeable membrane comprises an average pore size which can lie between 0.01 micrometer and 20 micrometers. The porosity lies preferably at approximately 50%; the average pore size preferably amounts to approximately 10 micrometers.

The semipermeable membrane can be preferably designed as a film-type or film-shaped or a disk-shaped thin membrane. The gas-permeable membrane comprises a membrane surface which is effective for gas permeation and preferably comprises a quadrangular or rectangular or round outer contour at its outer circumference. It is understood however that the outer circumference of the membrane can also be designed differently. The membrane is preferably a thin flat membrane whose membrane surfaces, effective for the gas passage and facing away from each other, are embodied substantially parallel to each other and preferably substantially of a planar configuration. It is understood however that the membrane can also be designed to be structured three-dimensionally.

At least the membrane cover part of the membrane covering the venting opening or the venting openings, preferably the entire membrane, is designed, viewed in its thickness direction, to be free of perforations or non-perforated so that a gas, in particular air, can diffuse through the membrane but substantially no water.

The membrane thickness of the membrane can be much smaller than its other outer dimensions. According to the invention, the membrane spans a minimum width and/or a minimum length or a minimum outer diameter of equal to or larger than 20 mm, preferably of equal to or larger than 30 mm, in particular of equal to or larger than 40 mm. The membrane thickness according to the invention is at least 20 times, preferably at least 40 times, in particular at least 100 times, smaller than the minimum width and/or the minimum length or the minimum outer diameter of the membrane. The membrane thickness can be preferably 1 micrometer to 5 millimeters, wherein the membrane can exhibit, at least across its effective membrane cover surface which is correlated with the membrane cover part, in particular across the entire membrane surface, a substantially constant membrane thickness. The membrane thickness can preferably amount to maximally 1 mm.

According to a beneficial embodiment of the degassing unit assembly, at least three degassing units can be arranged adjoining each other in a direction perpendicular to the axial direction of the degassing units, wherein at least two of the degassing units are designed as end pieces and at least one of the degassing units designed as a middle piece arranged between the two end pieces. In a manner similar to how a degassing unit assembly can be formed of two degassing units, an additional degassing unit as middle piece can be inserted between the two degassing units which are designed as end pieces in order to cover in this way a housing opening with larger cross section in a battery housing. In this context, the fastening domes and contact regions of the respectively joined degassing units can be designed in a matching manner so as to correspond with each other, respectively, so that the degassing unit can be joined with form fit in the manner of a puzzle. In this context, the membranes of the degassing units can be designed differently in order to fulfill various tasks, for example, emergency degassing and air pressure compensation.

According to a beneficial embodiment of the degassing unit assembly, the fastening dome can comprise a fastening flange which is projecting away from the rim and which, in the mounted state, is arranged at least partially overlapping the corresponding contact region of the adjoining degassing unit. In particular, the fastening flange can at least partially cover the contact region by means of an outwardly oriented collar. In this manner, the fastening flange can be arranged with the collar above the contact region and, in this way, additionally fix the contact region of the adjoining degassing unit when the fastening dome is connected by means of a screw to the battery housing, for example. In this way, a fastening unit in the contact region of the adjoining degassing unit can be saved.

Advantageously, in the degassing unit which is embodied as an end piece, the at least one fastening dome with the fastening flange can be oriented toward the adjoining degassing unit. In this way, by means of the fastening flange of one degassing unit the contact region of the adjoining degassing unit can be fixed.

According to a beneficial embodiment of the degassing unit assembly, in the degassing unit which is designed as a middle piece, fastening domes with fastening flange can be arranged diagonally opposite each other at the carrier body. In this way, the degassing units which are designed as middle piece can be arranged in a row in arbitrary number and, at the same time, can be connected in a suitable manner to a degassing unit designed as an end piece at the beginning of a row of degassing units.

According to a beneficial embodiment of the degassing unit assembly, the at least two adjoining degassing units can be connected with form fit in the overlap region, wherein the fastening flange of a fastening dome of a degassing unit forms the overlap region with the corresponding contact region of the adjoining degassing unit, in particular engages across the contact region. In this context, the fastening dome which is formed as a bulge of the rim of the carrier body of one degassing unit can engage snugly the contact region of the adjoining other degassing unit which is formed as a recess of the rim. In this manner, it is advantageously possible to adjacently arrange two degassing units so as to immediately adjoin each other.

According to a beneficial embodiment of the degassing unit assembly, at least one of the degassing units can comprise a semipermeable membrane for covering the gas through-opening. Advantageously, as semipermeable membrane a PTFE membrane can be used which is air-permeable but acts to block water and in this way ensures pressure compensation at normal pressure fluctuations due to temperature changes, weather changes or different altitudes in case of mobile use. In the other degassing unit, less expensive air-impermeable membranes as burst membranes can be used, for example, which enable a quick enlargement of the free cross section of the housing opening in case of an emergency degassing.

According to a further aspect of the invention, a degassing unit for a degassing unit assembly for closing a housing opening of a battery housing is proposed, comprising a carrier body which comprises a gas through-opening extending continuously through the carrier body in an axial direction for discharging gases or for pressure compensation. The carrier body comprises a rim surrounding the gas through-opening, which rim comprises at least one fastening dome and at least one contact region. In this context, the at least one fastening dome comprises a fastening flange comprising an outwardly curved collar and extending farther in axial direction than the rim.

Fastening dome and contact region are formed in the rim of the carrier body of the degassing unit, which rim, for example, can be embodied substantially planar.

With the degassing unit according to the invention, a degassing unit assembly as described above can be advantageously configured in a modular manner. The carrier body of the degassing unit comprises a gas through-opening which extends continuously through the carrier body in axial direction for discharging gases or for pressure compensation and which is covered completely by a membrane cover part of the membrane.

When a pressure peak is generated within the battery housing, for example, upon failure of a battery cell in the battery housing, this pressure must be relieved as quickly as possible because otherwise the housing might become damaged.

Usually, as semipermeable air-permeable but water-blocking membrane of a degassing unit, a PTFE membrane is used which contributes a large proportion of the total costs of a degassing unit.

According to a beneficial embodiment of the degassing unit, the contact region can have an extension in axial direction that is below the axial extension of the fastening flange. In this way, it is advantageously possible that the fastening flange of a fastening dome of an adjoining degassing unit engages with the collar formed at the fastening flange across the contact region and the adjoining degassing unit can be fixed in this way by the fixation of the fastening dome and the fastening flange of the first degassing unit at a battery housing.

According to a beneficial embodiment of the degassing unit, the at least one fastening dome with fastening flange can be formed as a bulge of the rim of the carrier body. As an alternative or in addition, the at least one contact region can be configured as a recess of the rim of the carrier body. In this manner, fastening dome and contact region of two degassing units can be connected by form fit upon joining the two degassing units in that the fastening dome and contact region snugly engage each other.

According to a beneficial embodiment of the degassing unit, the carrier body can be designed as a middle piece wherein two fastening domes with fastening flanges are arranged diagonally opposite each other and two contact regions are arranged diagonally opposite each other. In this manner, the degassing units embodied as middle piece can be connected to each other in a row in an arbitrary number and, at the same time, can be connected in a suitable manner to a degassing unit embodied as an end piece at the beginning of a row of degassing units.

According to a beneficial embodiment of the degassing unit, the gas through-opening can be covered completely at a carrier body inner side by a membrane cover part of a membrane, in particular of a semipermeable membrane, and can be provided on a carrier body outer side with an outer membrane guard body.

At least the membrane cover part of the membrane covering a venting opening or venting openings, preferably the entire membrane, is designed free of perforations or non-perforated, viewed in its thickness direction, so that a gas, in particular air, can pass through the membrane but substantially no water. By means of the outer membrane guard body comprising one or a plurality of gas passages for degassing a housing interior or for pressure compensation, which gas passage(s) is or are in gas communication via the gas-permeable membrane with gas through-perforations of the inner membrane guard body, an even better protection from handling-caused damages can be achieved while providing advantageous gas flow possibilities.

According to a beneficial embodiment of the degassing unit, the carrier body can comprise between the membrane and the outer membrane guard body a spike carrier with a spike which is oriented toward the membrane and which is provided for puncturing the membrane which is curved by a housing inner pressure in direction of the carrier body outer side.

When a pressure peak is generated within the battery housing, for example, upon failure of a battery cell in the battery housing, this pressure must be relieved as quickly as possible because otherwise the housing might become damaged. Advantageously, for this purpose a spike can be used as an emergency degassing spike which is positioned at a predetermined distance away from the membrane and punctures the latter when a predetermined differential pressure is surpassed and thus causes it to burst. Through the thus released gas through-opening, the generated gas pressure can be relieved.

According to a beneficial embodiment of the degassing unit, the carrier body can be fixedly connected to an inner membrane guard body which is arranged at its carrier body inner side and which contains a membrane support grid which engages across and, viewed in the direction toward the housing interior, engages from behind the membrane cover part of the membrane at a membrane inner side with a plurality of membrane support grid webs provided for supporting the membrane cover part of the membrane.

In case of membranes which, in comparison to their membrane thickness, have a large surface area or are large, there is the problem that the membrane during handling as well as due to the gas and/or water pressures acting at the site of use can be easily damaged and, at increased pressure, in particular increased water pressure, would be plastically deformed or would even break if no suitable measures are taken.

For this purpose, an inner membrane guard body is provided that contains a membrane support grid, which is preferably comprised of plastic material or metal and which engages across and, viewed in the direction toward the housing interior, engages from behind the membrane cover part of the membrane at the membrane inner side, which is facing the housing interior, by means of a plurality of membrane support grid webs, provided for supporting the membrane cover part of the membrane against handling-caused damages and against plastic deformations caused by the action of external gas and/or water pressure.

In this context, a plurality of grid openings in the form of gas through-perforations for degassing the housing interior or for a pressure compensation can be formed between the membrane support grid webs and are completely covered by the membrane cover part, preferably also substantially water-tightly closed. Either the membrane cover part rests immediately on support web outer surfaces of the membrane support grid webs so as to be supported thereon, preferably so as to be liftable therefrom, or is arranged at a minimal distance away from the support web outer surfaces of the membrane support grid webs in such a way that the membrane cover part of the membrane can be placed so as to be substantially elastically supported, i.e., substantially free of plastic or permanent deformations, on the support web outer surfaces of the membrane support grid webs, preferably so as to be liftable therefrom again. In this way, it can also be ensured that the water-repelling action of the membrane remains intact and a sufficiently large cross section remains effective through which the gas or the air can flow to the membrane inner side.

According to a beneficial embodiment of the degassing unit, the outer membrane guard body can comprise a plurality of gas passages which are spaced apart from each other, viewed laterally and in circumferential direction, and which are separated from each other by a plurality of approximately axially extending stays.

Due to the outer membrane guard body which comprises one or a plurality of gas passages for degassing a housing interior or for pressure compensation, which gas passage(s) is or are in gas communication via the gas-permeable membrane with the gas through-perforations of the inner membrane guard body, an even better protection against handling-caused damages can be achieved while providing advantageous gas flow possibilities.

According to a further aspect of the invention, a use of a degassing unit in a degassing assembly is proposed wherein the degassing unit respectively comprises at least a carrier body which comprises a gas through-opening extending continuously through the carrier body for discharging gases or for pressure compensation. The carrier body comprises respectively at least one fastening dome formed in a circumferentially extending rim and at least one contact region formed in the rim, wherein at least two degassing units in a direction perpendicular to an axial direction of the degassing units can be arranged adjoining each other, wherein at least two of the degassing units are designed as end pieces. In the mounted state, the at least one fastening dome of a degassing unit forms, at least in sections, an overlap region in axial direction with the corresponding at least one contact region of the adjoining degassing unit in this context.

According to the invention, for example, two degassing units can be used in order to form a degassing unit assembly in which the two degassing units, in a plane which corresponds to the surface normal of the degassing units, are arranged adjacent to each other, wherein one of the degassing units is rotated by 180° in relation to the other degassing unit. In this context, a respective fastening dome of a degassing unit can engage across the corresponding contact region of the respective adjoining other degassing unit, and the two degassing units in this manner can be connected immediately adjoining each other. In this arrangement, the thus formed degassing unit assembly can be connected to a battery housing via the two fastening domes and possibly existing further fastening devices and cover air-tightly and water-tightly a housing opening in the battery housing.

The inner membrane guard body and the membrane and/or the membrane and the carrier body and/or the inner membrane guard body and the carrier body can be connected to each other, in particular water-tightly, by means of a seal element, which is attached to the inner membrane guard body or the carrier body or is configured as a separate component, preferably by a two-component technology.

It can be particularly advantageous when the inner membrane guard body at its outer side which is facing the membrane comprises a ring-shaped membrane fastening projection, extending completely circumferentially without interruption, in particular in the form of a thin stay or a thin strip, wherein the ring-shaped membrane fastening projection encloses or surrounds completely circumferentially a through hole of the inner membrane guard body and laterally delimits it, which spans an inner cross section which is larger than an added-up inner diameter of a plurality of gas through-perforations or of all gas through-perforations, and wherein a plurality of gas through-perforations or all gas through-perforations open jointly into the aforementioned through hole, and that the membrane is connected, in particular welded or glued, to the ring-shaped membrane fastening projection, preferably also to the carrier body in one working step, in particular to its ring-shaped inner contact surface, with formation of a substantially water-tight connection. In this way, a further improvement in the meaning of the aforementioned advantages can be achieved.

According to a beneficial configuration, at least three degassing units can be arranged adjoining each other in a direction perpendicular to an axial direction of the degassing units, wherein at least two of the degassing units are formed as end pieces and at least one of the degassing units as middle piece, wherein the degassing unit forming the middle piece is arranged between the two degassing units forming the end pieces.

In a manner similar to how a degassing unit assembly can be formed of two degassing units, a further degassing unit as middle piece can be inserted between the two degassing units embodied as end pieces in order to cover in this way a housing opening with a larger cross section in a battery housing. In this context, the fastening domes and contact regions of the respective joined degassing units can be designed in a matching manner to mutually correspond to each other, respectively, so that the degassing units can be joined like a puzzle. The membranes of the degassing units can be differently designed in this context.

According to a further aspect of the invention, a battery housing with a degassing unit assembly is proposed, comprising a housing comprising a housing opening and enclosing a housing interior, wherein the housing opening is covered by means of the degassing unit assembly which is provided for degassing or for pressure compensation and for substantially water-tight sealing of the housing interior against ingress of water and which is substantially water-tightly connected to the housing.

The battery housing according to the invention serves for receiving one or a plurality of batteries or rechargeable batteries which are arranged, for example, as cells in the battery housing. Particularly preferred, the battery housing serves for receiving one or a plurality of lithium ion batteries. A battery or a rechargeable battery with such a battery housing can be used in particular in vehicles for supplying electric energy, particularly preferred in vehicles with an electric motor drive which has a high electrical energy need. The battery housing comprises at least one degassing opening which inter alia serves for discharging gases produced by chemical processes in the batteries or rechargeable batteries to the exterior into the atmosphere. As needed, a plurality of degassing openings can be present also. The or the respective degassing opening is connected in flow communication to the batteries or rechargeable batteries received in the battery housing and extends to the outer housing side of the battery housing.

According to the invention, the degassing opening is covered by a degassing unit assembly with at least two degassing units, in particular wherein at least one degassing unit comprises a semipermeable membrane which is gas-permeable but at least substantially water-tight. The membrane ensures that the gases produced in the batteries or rechargeable batteries pass through the membrane to the exterior and are discharged into the atmosphere. At the same time, an ingress of water from the exterior to the interior, which could lead to a functional limitation or even to a destruction, is reliably prevented.

### BRIEF DESCRIPTION OF DRAWINGS

Further advantages result from the following drawing description. In the drawings, embodiments of the invention are illustrated. The drawings, the description, and the claims contain numerous features in combination. A person of skill in the art will expediently consider the features also individually and combine them to expedient further combinations.

FIG. 1 shows an isometric view of a degassing unit embodied as an end piece according to an embodiment of the invention, viewed from a carrier body outer side.

FIG. 2 shows an isometric view of the degassing unit according to FIG. 1, viewed from a carrier body inner side.

FIG. 3 shows a side view of the degassing unit according to FIG. 1.

FIG. 4 shows a longitudinal section of the degassing unit according to FIG. 1.

FIG. 5 shows an isometric view of a degassing unit embodied as a middle piece according to a further embodiment of the invention, viewed from a carrier body outer side.

FIG. 6 shows an isometric view of the degassing unit according to FIG. 5 viewed from a carrier body inner side.

FIG. 7 shows a side view of the degassing unit according to FIG. 5.

FIG. 8 shows a plan view of three degassing units prior to assembly to a degassing unit assembly according to an embodiment of the invention.

FIG. 9 shows an isometric view of a degassing unit assembly embodied of three degassing units according to an embodiment of the invention, viewed from a carrier body outer side.

FIG. 10 shows an isometric view of the degassing unit assembly according to FIG. 9 viewed from a carrier body inner side.

FIG. 11 shows a side view of the degassing unit assembly according to FIG. 9.

FIG. 12 shows a longitudinal section of the degassing unit assembly according to FIG. 9.

### DETAILED DESCRIPTION

In the Figures, same or same-type components are identified with same reference characters. The Figures show only examples and are not to be understood as limiting.

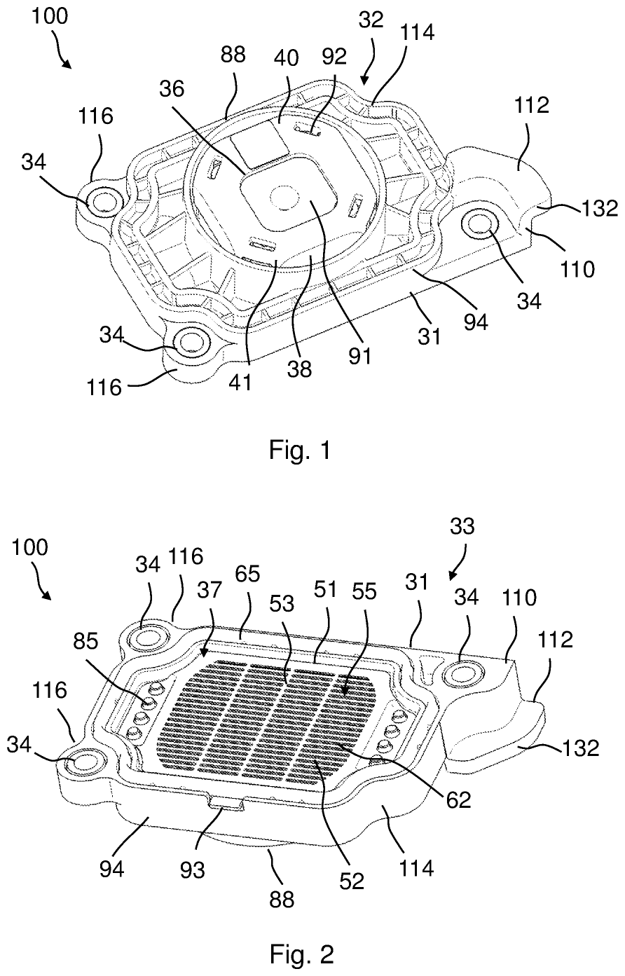

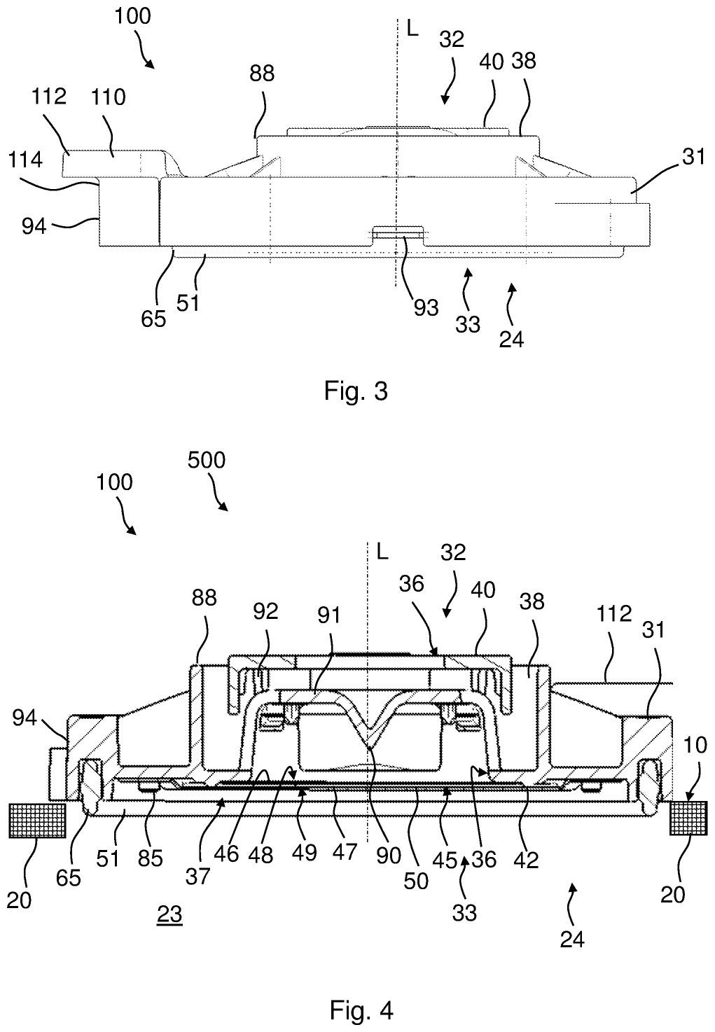

FIG. 1 shows an isometric view of a degassing unit 100 embodied as an end piece for a degassing unit assembly 500 (FIG. 4) for closing a housing opening 24 of a battery housing 20 (FIG. 4) according to an embodiment of the invention, viewed from a carrier body outer side 32. FIG. 2 shows the degassing unit 100 according to FIG. 1, viewed from a carrier body inner side 33, while in FIG. 3 a side view of the degassing unit 100 and in FIG. 4 a longitudinal section is illustrated.

The battery housing 20 is illustrated only schematically in FIG. 4 with a housing interior 23 as well as the housing opening 24.

The degassing unit 100 comprises a carrier body 31 which comprises a gas through-opening 36 extending continuously through the carrier body 31 in an axial direction L for discharging gases or for pressure compensation. The carrier body 31 comprises a rim 94 surrounding the gas through-opening 36 and comprising a fastening dome 110 and a contact region 114. The fastening dome 110 comprises a fastening flange 112 comprising an outwardly curved collar 132 and extending in axial direction L farther than the rim 94, as can be seen in particular in FIG. 3.

Fastening dome 110 and contact region 114 are arranged in corners of the carrier body 31. At the two other corners, further fastening domes 116 without fastening flange are arranged. The three fastening domes 110, 116 each have sleeve inserts 34, preferably of metal, for example, of brass, in order to fixedly screw the degassing unit 100 to a battery housing 20.

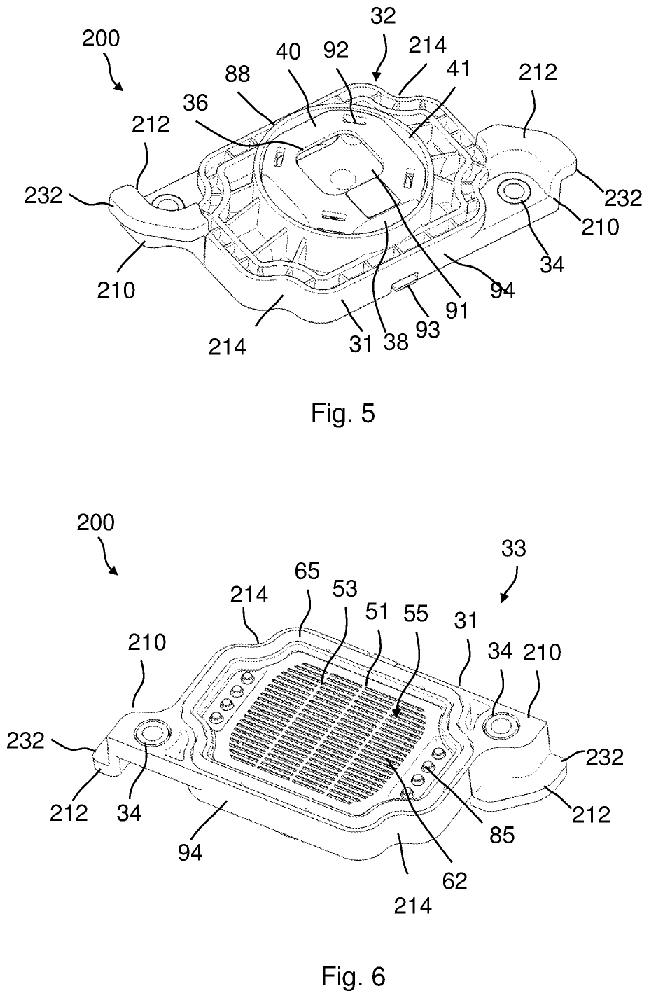

The degassing unit 100 forms an end piece of a degassing unit assembly 500 (FIG. 4). When the degassing unit 100 is joined with a further degassing unit 100, rotated by 180° about the axial direction, a degassing unit assembly 500 with two end pieces is formed thereby. One or a plurality of degassing units 200 (FIG. 5) embodied as middle pieces can be arranged between the two end pieces.

As can be seen in FIG. 3, the contact region 114, 214 comprises in axial direction L an extension which lies below the axial extension of the fastening flange 112, 212.

The fastening dome 110 with fastening flange 112 is formed as a bulge of the rim 94 of the carrier body 31 while the contact region 114 is embodied as a recess of the rim 94 of the carrier body 31.

As can be seen in the longitudinal section in FIG. 4, the gas through-opening 36 is covered completely at the carrier body inner side 33 by a membrane cover part 50 of a membrane 45, in particular a semipermeable membrane 45. On the carrier body outer side 32, the gas through-opening 36 comprises an outer membrane guard body 40.

The membrane 45 which is placed into the degassing unit 100 can be seen from the exterior by means of a visible tab 93.

Between the membrane 45 and the outer membrane guard body 40, the carrier body 31 comprises a spike carrier 91 with a spike 90 oriented toward the membrane 45 and provided for puncturing the membrane 45 curved by an inner housing pressure in the direction of the carrier body outer side 32 in case of an emergency degassing with greatly increasing excess pressure in the battery housing 20.

Instead of by means of the spike 90, an emergency degassing by rupture of the membrane 45 can be carried out alternatively, for example, by perforation of the membrane 45 prior to mounting in the degassing unit 100, 200, for example, by a laser but also by the attachment of the membrane 45 at the carrier body 31.

The carrier body 31 is fixedly connected to an inner membrane guard body 51 arranged at its carrier body inner side 33 and containing a membrane support grid 52 (see FIG. 2) which engages across and, viewed in direction toward the housing interior 23 of the battery housing 20, engages from behind the membrane cover part 50 of the membrane 45 at an inner membrane side 49 of the inner membrane surface 47 with a plurality of membrane support grid webs 53 provided for supporting the membrane cover part 50 of the membrane 45. The inner membrane guard body 51 is connected by an outwardly circumferentially extending frame 65 to the carrier body 31 and engages by means of the frame 65 a groove circumferentially extending in the carrier body 31 at the carrier body inner side 33.

The inner membrane guard body 51 can be embodied, for example, of metal. As an alternative, it can be manufactured of plastic material. For example, the use of polypropylene with a glass fiber contents of 30% (PPG 30) or polyamide is possible.

In the installed state, the membrane 45, at its membrane outer side 48, covers with the membrane cover part 50 the central through-opening 37 of the gas through-opening 36 of the carrier body 31. At the membrane outer side 48, it rests with its membrane outer surface 46 on the ring-shaped inner contact surface 42 of the carrier body 31. The membrane 45 covers the central through-opening 37 of the gas through-opening 36 completely and closes the latter substantially water-tightly, preferably also substantially air-tightly or even gas-tightly.

Grid openings 55 in the form of gas through-perforations 62 for degassing the housing interior 23 or for a pressure compensation are formed between the membrane support grid webs 53. The grid openings 55 are covered by the membrane cover part 50 of the membrane 45.

The grid openings 55 are advantageously sized standardized such that no foreign body which surpasses a predetermined size can damage the membrane 45.

As can be seen in FIG. 2, the carrier body 31 comprises at its inner side 33 which is facing the housing interior 23, at both sides of the central gas through-opening 37, a number of fixation knobs 85 which serve for at least temporary fixation and positioning of the inner membrane guard body 51 with the membrane 45, positioned between the latter and the carrier body 31, at the carrier body 31. The fixation knobs 85 can be embodied, for example, for hot stamp connections and/or for connections by ultrasonic welding.

The outer membrane guard body 40 comprises a plurality of gas passages 38 which, viewed laterally and in circumferential direction, are arranged spaced apart from each other and which are separated by a plurality of approximately axially extending stays 41.

The outer membrane guard body 40 is arranged in a carrier body flange 88 and is fixed in the carrier body 31 by locking with locking elements 92.

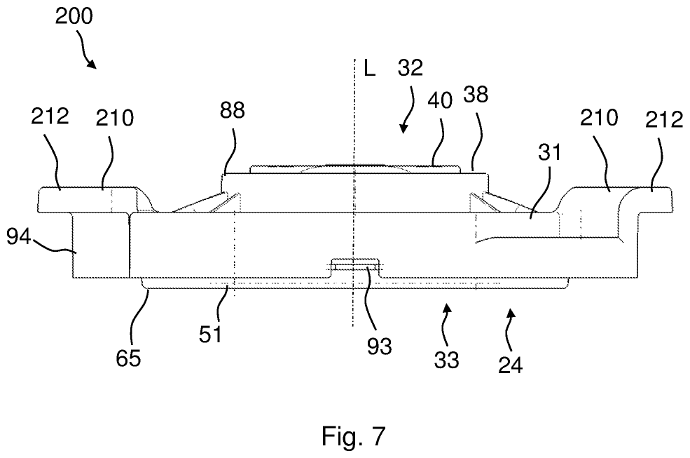

FIG. 5 shows an isometric view of a degassing unit 200 embodied as a middle piece according to a further embodiment of the invention, viewed from carrier body outer side 32. FIG. 6 shows an isometric view of the degassing unit 200 according to FIG. 5, viewed from a carrier body inner side 33, while in FIG. 7 a side view of the degassing unit 200 is illustrated.

The fundamental configuration of the degassing unit 200 embodied as a middle piece coincides with the configuration of the degassing unit 100 illustrated in FIGS. 1 through 4 and embodied as an end piece. For avoiding unnecessary repetitions, reference is being had to the description of FIGS. 1 to 4.

The significant differentiating features in relation to the degassing unit 100

lie in the arrangement of the fastening domes 210 and of the contact regions 214 in the degassing unit 200 embodied as a middle piece. In the degassing unit 200 embodied as a middle piece, two fastening domes 210 with fastening flanges 212 are arranged diagonally opposite each other and two contact regions 214 are also arranged diagonally opposite each other. Fastening domes 210 and contact regions 214 are thus positioned crosswise to each other.

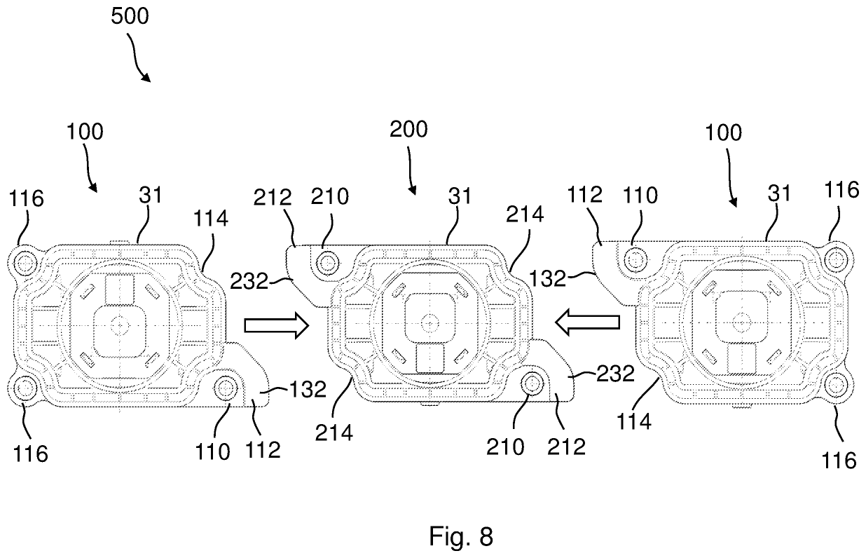

In FIG. 8, a plan view of three degassing units 100, 200 prior to the assembly to a degassing unit assembly 500 according to an embodiment of the invention is illustrated. Two of the degassing units 100 are embodied as end pieces wherein the two degassing units 100 in this context are mounted rotated by 180° relative to each other while the third degassing unit 200 is embodied as a middle piece which is arranged between the two degassing units 100 embodied as end pieces. In this context, the three degassing units 100, 200 are pushed together in a linear movement, indicated by the two arrows, so that the respective fastening domes 110, 210 with their fastening flanges 112, 212 and the corresponding contact regions 114, 214 immediately adjoin each other and can be mounted with form fit in this way.

In an alternative embodiment, not illustrated, degassing units 100, 200 can also be joined not in a linear arrangement but as two-dimensional areally expanding arrangement and thus cover a larger housing opening 24.

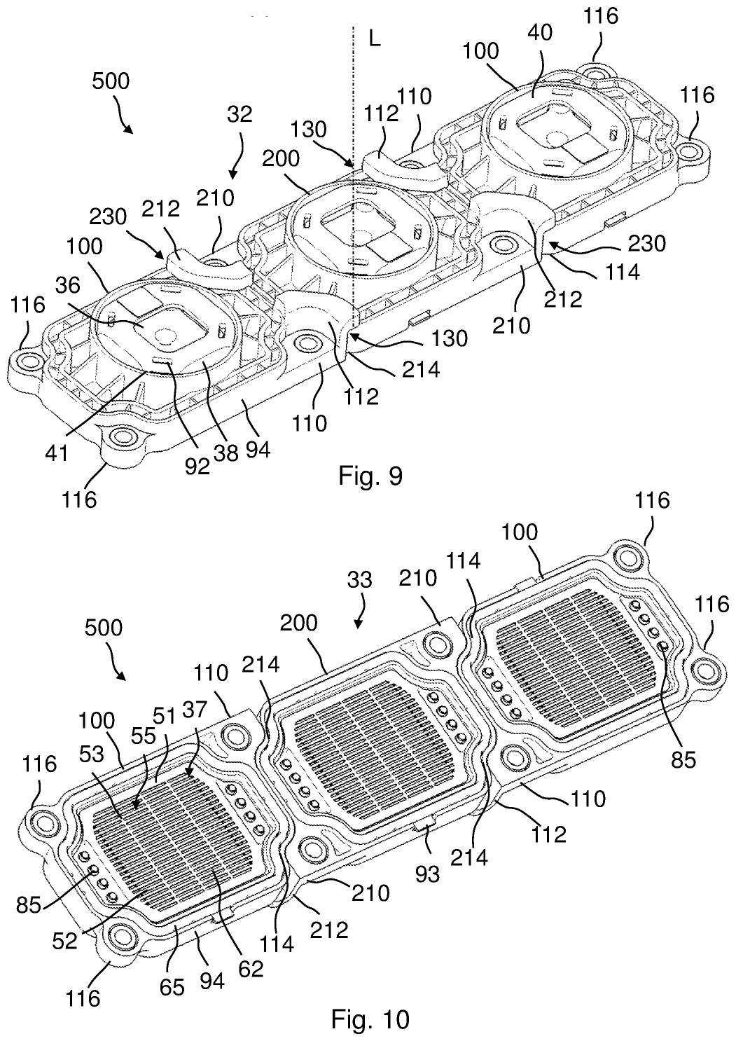

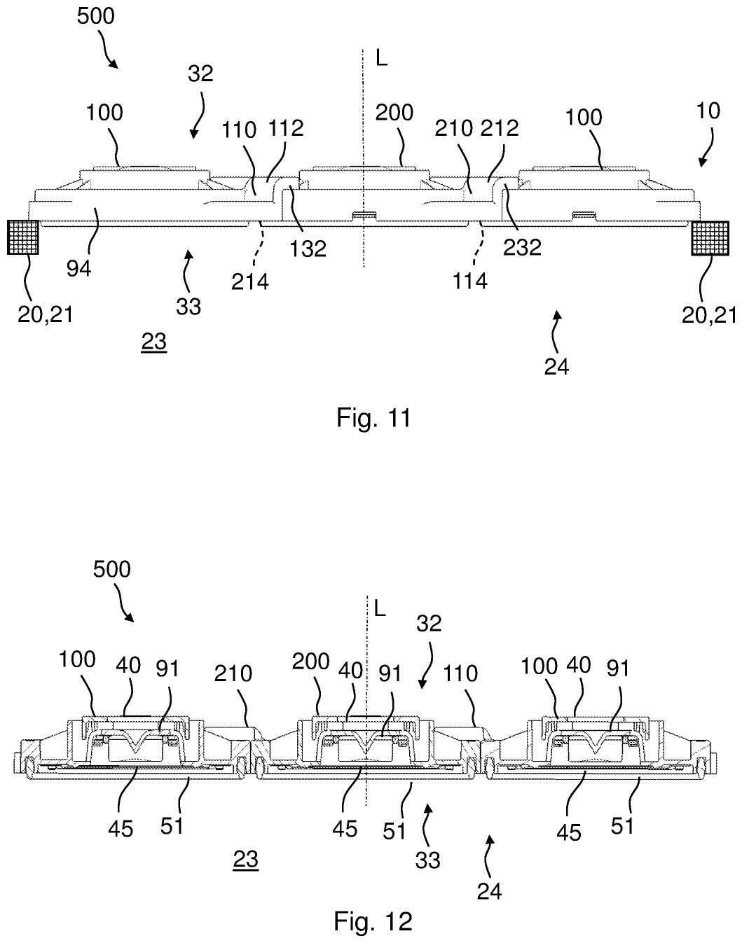

FIG. 9 shows in this respect an isometric view of a degassing unit assembly 500 formed of the three degassing units 100, 200 according to an embodiment of the invention, viewed from a carrier body outer side 32. FIG. 10 shows an isometric view of the degassing unit assembly 500 according to FIG. 9, viewed from a carrier body inner side 33, while in FIG. 11 a side view of the degassing unit assembly 500 according to FIG. 9 and in FIG. 12 a longitudinal section of the degassing unit assembly according to FIG. 9 is illustrated.

The degassing unit assembly 500 for closing a housing opening 24 of a battery housing 20 comprises three degassing units 100, 200 which are arranged adjoining each other in a direction perpendicular to an axial direction L corresponding to a surface normal of the degassing units 100, 200. Two of the degassing units 100 are embodied as end pieces and one of the degassing units 200 as a middle piece which is positioned between the two end pieces.

The degassing units 100, 200 respectively comprise a carrier body 31 which comprises a gas through-opening 36 extending continuously through the carrier body 31 in axial direction L for discharging gases or for pressure compensation.

The carrier body 31 respectively comprises at least one rim 94 surrounding the gas through-opening 36 and comprising at least one fastening dome 110, 210 and at least one contact region 114, 214 formed in the rim 94. In the mounted state, the at least one fastening dome 110, 210 of a degassing unit 100, 200 forms, at least in sections, an overlap region 130, 230 in axial direction L with the corresponding at least one contact region 114, 214 of the adjoining degassing unit 100, 200.

The fastening dome 110, 210 comprises a fastening flange 112, 212 projecting away from the rim 94 which, in the mounted state, is arranged at least partially in overlap with the corresponding contact region 114, 214 of the adjoining degassing unit 100, 200. In particular, the fastening flange 112, 212 covers with an outwardly oriented collar 132, 232 the contact region 114, 214 at least partially. In the adjoined state of the degassing units 100, 200, the contact region 114, 214 is therefore not visible from the carrier body outer side 32.

In the degassing unit 200 embodied as a middle piece, two fastening domes 210 with fastening flanges 212 are arranged diagonally opposite each other at the carrier body 31.

The degassing units 100, 200 adjoining each other are connected with form fit in the overlap region 130, 230, wherein the fastening flange 112, 212 of a fastening dome 110, 210 of a degassing unit 100, 200 forms the overlap region 130, 230 with the corresponding contact region 114, 214 of the adjoining degassing unit 100, 200. In particular, the fastening flange 112, 212 engages across the contact region 114, 214, and the fastening dome 110, 210, embodied as a bulge of the rim 94 of the carrier body 31, of one degassing unit 100, 200 snugly engages the contact region 114, 214, embodied as a recess of the rim 94, of the adjoining other degassing unit 100, 200.

At least one of the degassing units 100, 200 comprises a semipermeable membrane 45 for covering the gas through-opening 36. Advantageously, as a semipermeable membrane 45, a membrane, for example, of extruded PTFE, can be used which is air-permeable, but acts to block water and in this way ensures the pressure compensation for normal pressure fluctuations due to temperature changes, weather changes or different altitudes in mobile use.

The other degassing units 100, 200 can comprise as a membrane 45 a non-porous membrane 45 which seal-tightly closes the gas through-opening 36 and, in an emergency degassing situation upon strong pressure increase in the battery housing 20, ruptures due to a spike 90 or an intrinsically arranged rated break point of the membrane 45. In this way, advantageously a functional separation of the degassing units 100, 200 can be realized which can contribute to cost savings for the manufacturing costs of the degassing units 100, 200.

The battery housing 20 which is only schematically indicated in FIG. 11 by connection locations at the ends of the degassing unit assembly 500 comprises a housing 21 comprising the housing opening 24 and enclosing the housing interior 23. The housing opening 24 is covered by the degassing unit assembly 500 which is provided for degassing or for pressure compensation and for substantially water-tight sealing of the housing interior 23 against ingress of water and which is substantially water-tightly connected to the housing 21.

1. A degassing unit assembly for closing a housing opening of a battery housing, the degassing unit assembly comprising:
degassing units arranged adjoining each other in a direction perpendicular to an axial direction corresponding to a surface normal of the degassing units, each of the degassing units comprising a carrier body comprising:
a gas through-opening configured to discharge gases or to provide pressure compensation, the gas through-opening extending continuously through the carrier body in the axial direction; and
a rim surrounding the gas through-opening, the rim comprising at least one fastening dome and at least one contact region formed in the rim,
wherein at least two of the degassing units are end pieces, respectively,
wherein, in a mounted state of the degassing units, the at least one fastening dome of the carrier body of a first one of the degassing units forms, at least in sections, an overlap region in the axial direction with the at least one contact region of the carrier body of a second one of the degassing units adjoining the first one of the degassing units,
wherein the at least one fastening dome of the carrier body of the first one of the degassing units comprises a fastening flange projecting away from the rim, the fastening flange, in the mounted state, being arranged at least partially in overlap with the at least one contact region of the carrier body of the second one of the degassing units, and
wherein the fastening flange comprises an outwardly oriented collar overlapping at least partially the at least one contact region of the carrier body of the second one of the degassing units.

2. The degassing unit assembly according to claim 1, wherein, in a direction perpendicular to the axial direction of the degassing units, three or more of the degassing units are arranged adjoining each other,
wherein the three or more degassing units comprise the end pieces, and
wherein at least one of the three or more degassing units is a middle piece arranged between the end pieces.

3. The degassing unit assembly according to claim 2, wherein the middle piece comprises two of the fastening domes arranged diagonally opposite each other at the carrier body, and
wherein each of the two fastening domes comprises a fastening flange.

4. The degassing unit assembly according to claim 1, wherein the first one of the degassing units and the second one of the degassing units are connected with form fit in the overlap region, and
wherein the fastening flange forms the overlap region with the at least one contact region of the carrier body of the second one of the degassing units.

5. The degassing unit assembly according to claim 4, wherein the fastening flange engages across the at least one contact region of the carrier body of the second one of the degassing units.

6. The degassing unit assembly according to claim 4, wherein the at least one fastening dome of the carrier body of the first one of the degassing units is embodied as a bulge of the rim of the carrier body of the first one of the degassing units,
wherein the at least one contact region of the carrier body of the second one of the degassing units is embodied as a recess of the rim of the carrier body of the second one of the degassing units, and
wherein the bulge snugly engages the recess.

7. The degassing unit assembly according to claim 1, wherein at least one of the degassing units comprises a semipermeable gas-permeable membrane covering the gas through-opening.

8. The degassing unit assembly according to claim 7, wherein at least another one of the degassing units comprises a membrane covering the gas through-opening, the membrane being not gas-permeable.

9. A degassing unit for a degassing unit assembly for closing a housing opening of a battery housing, the degassing unit comprising:
a carrier body comprising:
a gas through-opening extending continuously through the carrier body in an axial direction, the gas through-opening being configured to discharge gases or to provide pressure compensation; and
a rim surrounding the gas through-opening, the rim comprising one or more fastening domes and one or more contact regions,
wherein each of the one or more fastening domes comprises a fastening flange comprising an outwardly curved collar and extending farther in the axial direction than the rim.

10. The degassing unit according to claim 9, wherein, in the axial direction, each of the one or more contact regions has an extension below an axial extension of the one or more fastening flanges, respectively.

11. The degassing unit according to claim 9, wherein the one or more fastening domes are embodied as a bulge of the rim of the carrier body, respectively.

12. The degassing unit according to claim 9, wherein the one more contact regions are embodied as a recess of the rim of the carrier body, respectively.

13. The degassing unit according to claim 9, wherein the one or more fastening domes are embodied as a bulge of the rim of the carrier body, respectively, and
wherein the one or more contact regions are embodied as a recess of the rim of the carrier body, respectively.

14. The degassing unit according to claim 9, wherein the carrier body is a middle piece,
wherein the one or more fastening domes comprise two fastening domes arranged diagonally opposite each other, and
wherein the one or more contact regions comprise two contact regions arranged diagonally opposite each other.

15. The degassing unit according to claim 9, further comprising:
a membrane comprising a membrane cover part, the gas through-opening being covered completely by the membrane cover part at a carrier body inner side of the carrier body, and the carrier body inner side facing a housing interior of the battery housing; and
an outer membrane guard body arranged at a carrier body outer side of the carrier body and covering the gas through-opening, the carrier body outer side facing away from the housing interior of the battery housing.

16. The degassing unit according to claim 15, wherein the membrane is a semipermeable membrane.

17. The degassing unit according to claim 15, wherein the carrier body further comprises a spike carrier with a spike, the spike carrier being arranged between the membrane and the outer membrane guard body, and
wherein the spike is oriented toward the membrane and being configured to puncture the membrane when the membrane is curved by an inner housing pressure of the battery housing in a direction toward the carrier body outer side.

18. The degassing unit according to claim 15, further comprising an inner membrane guard body arranged at the carrier body inner side of the carrier body and fixedly connected to the carrier body, the inner membrane guard body comprising a membrane support grid engaging across and, viewed in a direction toward the housing interior of the battery housing, engaging from behind the membrane cover part of the membrane on an inner membrane side,
wherein the membrane support grid comprises a plurality of membrane support grid webs configured to support the membrane cover part of the membrane at the inner membrane side.

19. The degassing unit according to claim 15, wherein the outer membrane guard body comprises a plurality of gas passages, and
wherein the gas passages, viewed laterally and in a circumferential direction, are arranged spaced apart from each other and are separated from each other by a plurality of approximately axially extending stays.

20. A battery housing comprising:
a housing comprising a housing opening and enclosing a housing interior; and
a degassing unit assembly according to claim 1, the degassing unit assembly being arranged at the housing to cover the housing opening, the degassing unit assembly being configured to discharge gases or to provide pressure compensation and to substantially water-tightly seal the housing interior against ingress of water, and the degassing unit assembly being substantially water-tightly connected to the housing.
